(19) United States
(12) Patent Application Publication
(10) Pub. No.: US 2026/0332389 A1
(43) Pub. Date: Oct. 22, 2026

(54) METHOD AND SYSTEM FOR GAMING RANDOM NUMBER GENERATION

(71) Applicant: Nan-Hsuan HSU, Taichung City (TW)

(72) Inventor: Nan-Hsuan HSU, Taichung City (TW)

(21) Appl. No.: 19/540,148

(22) Filed: Feb. 13, 2026

Related U.S. Application Data
(60) Provisional application No. 63/792,524, filed on Apr. 22, 2025.

(30) Foreign Application Priority Data
Nov. 14, 2025 (CN) 202511666678.8

(51) Int. Cl. H04L 9/06

(52) U.S. Cl. CPC H04L 9/0643

(57) ABSTRACT

A method for gaming random number (RN) generation is implemented by a server device that is adapted to be communicatively connected to a first blockchain and a second blockchain. The method includes: generating an RN generation parameter based on at least one randomness parameter and a blockchain parameter that is obtained from the first blockchain; generating n number of leaf node hashes using a hash function based on the RN generation parameter and n number of node identifiers, where n>1; generating a root hash using a Merkle tree construction algorithm based on the n number of leaf node hashes; and sending the root hash to a second blockchain so as to store the root hash in the second blockchain.

### CROSS-REFERENCE TO RELATED APPLICATION

This application claims the benefit of U.S. Provisional Patent Application No. 63/792,524, filed on Apr. 22, 2025, and claims priority to Chinese Invention Patent Application No. 202511666678.8, filed on Nov. 14, 2025, the entire disclosures of which are incorporated by reference herein.

### FIELD

The disclosure relates to a method and system for gaming random number generation.

### BACKGROUND

A conventional method of random number generation for gaming that is used in common gaming machines (e.g., slot machines, fish-hunting machines) or loot-drop mechanisms in online games (e.g., Diablo® and Path of Exile®) generally rely on random number generation algorithms implemented by the gaming machine itself or by the official online game system to produce random numbers. The random numbers thus generated are used to determine the rewards or virtual items a player may obtain in the game.

However, such random number generation algorithms are typically part of the internal system code, and lack openness and transparency. Players are unable to trace or verify the random number generation process, making it difficult to ensure fairness and impartiality of the random numbers thus generated. In addition, the random numbers generated by using the conventional method of random number generation may be susceptible to tampering or manipulation due to the proprietary programming or the control exerted by a game operator, thereby causing the players to doubt their credibility. Furthermore, should the conventional method of random number generation be integrated with cryptographic techniques to improve fairness and impartiality, it may necessitate a prolonged response time, and thus fail to meet the demands of application scenarios such as loot-driven games that may require high-frequency random number outputs.

In view of the above, the conventional method of random number generation for gaming suffers from deficiencies in traceability, fairness, and verifiability and it is not tamper-proof; moreover, when augmented with cryptographic techniques to address these issues, its capability for high-frequency generation of random numbers is restricted, consequently it may fail to meet the demands of relevant applications.

### SUMMARY

Therefore, an object of the disclosure is to provide a method and a system for gaming random number generation that can alleviate at least one of the drawbacks of the prior art.

According to an aspect of the disclosure, the method for gaming random number (RN) generation is implemented by the system that includes a server device. The server device is adapted to be communicatively connected to a first blockchain and a second blockchain. The method includes steps of, by the server device: generating an RN generation parameter based on at least one randomness parameter and a blockchain parameter that is obtained from the first blockchain, where the RN generation parameter includes the at least one randomness parameter and the blockchain parameter; generating n number of leaf node hashes using a hash function based on the RN generation parameter and n number of node identifiers, where the n number of node identifiers are different from each other, the n number of leaf node hashes are different from each other, and n>1; generating a root hash using a Merkle tree construction algorithm based on the n number of leaf node hashes; and sending the root hash to the second blockchain so as to store the root hash in the second blockchain.

According to another aspect of the disclosure, the system for gaming RN generation includes a server device that is adapted to be communicatively connected to a first blockchain and a second blockchain. The server device is configured to perform the method mentioned above for generating the n number of leaf node hashes and the root hash.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic block diagram illustrating a system for implementing a method for gaming random number generation in an application scenario according to the present disclosure.

FIG. 2 is a flow chart illustrating a random number generation procedure according to an embodiment of the present disclosure.

FIG. 3 is a flow chart illustrating a random number parameter generation procedure according to the embodiment of the present disclosure.

FIG. 4 is a flow chart illustrating a leaf node generation procedure according to the embodiment of the present disclosure.

FIG. 5 is a flow chart illustrating a random number on-chain upload procedure according to the embodiment of the present disclosure.

FIG. 6 is a flow chart illustrating a random number exchange procedure according to the embodiment of the present disclosure.

FIG. 7 is a flow chart illustrating a verification procedure.

FIG. 8 is a flow chart illustrating another verification procedure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

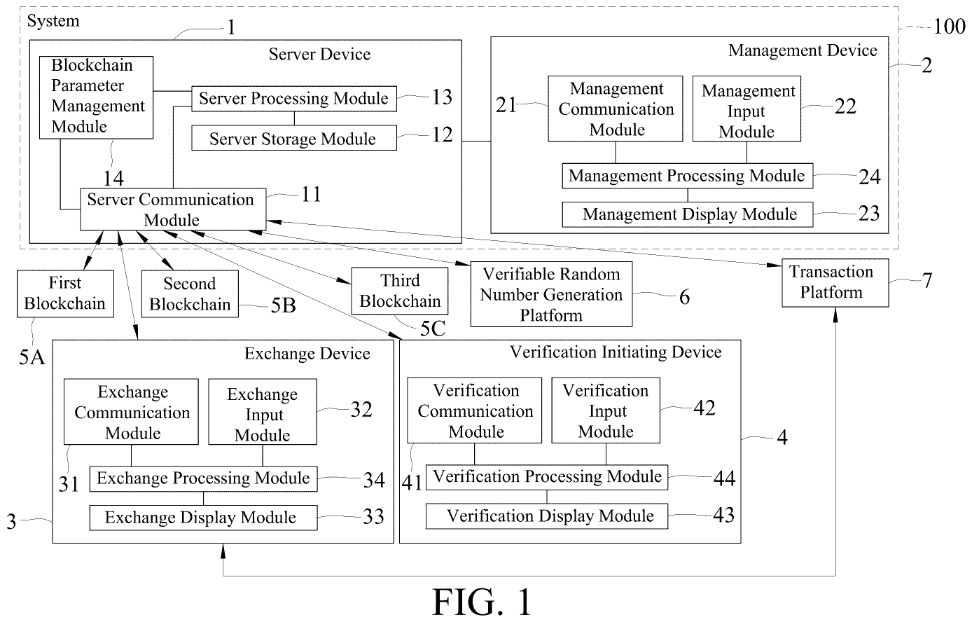

Referring to FIG. 1, a system 100 for implementing a method for gaming random number generation according to an embodiment of the present disclosure includes a server device 1, and a management device 2 that is communicatively connected to the server device 1 through a communication network. In one embodiment, the communication network may be exemplified as the local area network (LAN) or Internet, using physical networking hardware such as fiber optics, Ethernet and a router, and/or via a wireless communication module such as a Wi-Fi module, but the disclosure is not limited in this respect. In another embodiment, the server device 1 and the management device 2 are coupled via physical lines, or integrated into a single device.

In this embodiment, the management device 2 is used by an administrator to manage the server device 1, and includes a management processing module 24 (e.g., a microprocessor unit (MCU)), and a management communication module 21 (e.g., a Wi-Fi module), a management input module 22 (e.g., a touchscreen module or a keyboard module), and a management display module 23 (e.g., a display) that are electrically connected to the management processing module 24. The management device 2 may be exemplified by a laptop, a notebook computer, a smart phone device or a desktop computer, although the management device 2 is not limited to such. The management device 2 is operable by the administrator to generate a random number (RN) generation request that includes a generation quantity which indicates a quantity of random numbers (RNs) to be generated. Specifically, the management input module 22 is operable by the administrator (e.g., keying in a value using the keyboard) to generate and output an administrator input signal that includes the quantity (i.e., the value that was keyed in) of RNs to be generated to the management processing module 24. The management processing module 24 is configured to, in response to receipt of the administrator input signal, control the management display module 23 to display the quantity of RNs to be generated based on the administrator input signal, generate the RN generation request based on the administrator input signal, and send the RN generation request to the server device 1 via the management communication module 21 through the communication network.

The server device 1 includes a server processing module 13 (e.g., an MCU), and a server communication module 11 (e.g., a Wi-Fi module), a server storage module 12 (e.g., a solid state drive or a hard disk drive) and a blockchain parameter management module 14 that are electrically connected to the server processing module 13. The server device 1 may be implemented by a server, a laptop, a notebook computer, a smart phone device or a desktop computer, although the server device 1 is not limited to such. The server device 1 is configured to receive the RN generation request from the management device 2, and to generate and output RNs based on the RN generation request.

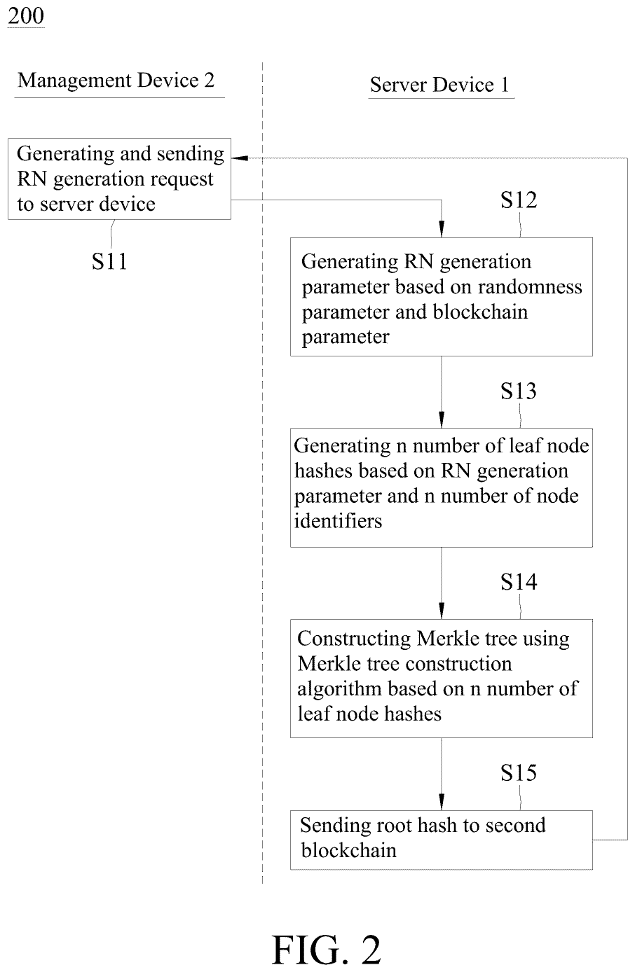

Referring to FIG. 2, the method for gaming RN generation includes an RN generation procedure 200. The RN generation procedure 200 includes steps of S11 to S15.

In step S11, the management device 2 generates the RN generation request and sends the RN generation request to the server device 1. For ease of illustration, hereinafter, the quantity of RNs to be generated will be referred to simply as “n”, where n>1. That is, the RN generation request includes the generation quantity which indicates that n RNs are to be generated.

The blockchain parameter management module 14 is configured to manage parameters for a first blockchain 5A, a second blockchain 5B, and a third blockchain 5C. In one embodiment, the blockchain parameter management module 14 may be implemented in a software, executable by the server processing module 13 and stored in the server storage module 12, and may manifest as an application, a program, or a smart-contract interaction interface, but the disclosure is not limited to such.

In step S12, the server processing module 13, in response to receipt of the RN generation request via the server communication module 11, obtains at least one randomness parameter from a verifiable RN generation platform 6, and a blockchain parameter from the first blockchain 5A. Then, the server processing module 13 generates an RN generation parameter based on the at least one randomness parameter and the blockchain parameter, and stores the RN generation parameter in the server storage module 12. Specifically, the RN generation parameter includes the at least one randomness parameter and the blockchain parameter.

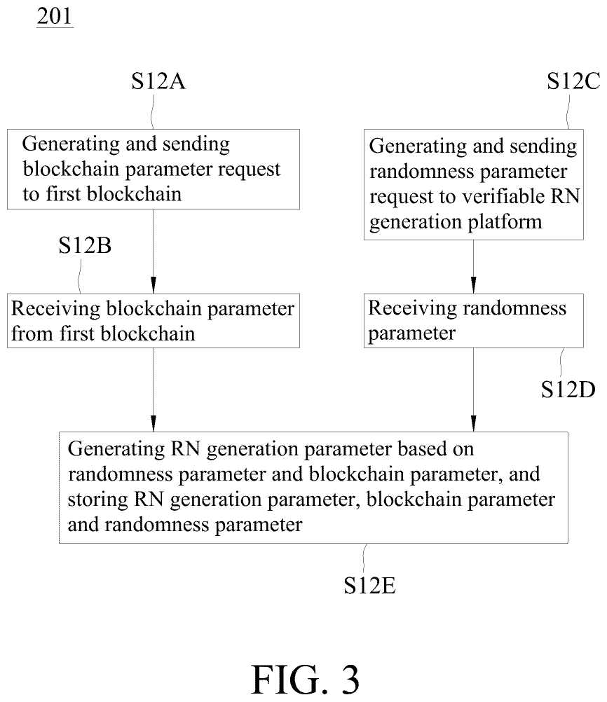

Further referring to FIG. 3, step S12 includes an RN parameter generation procedure 201, which includes sub-steps S12A to S12E.

In sub-step S12A, the server processing module 13, in response to receipt of the RN generation request, initiates the blockchain parameter management module 14 to generate a blockchain parameter request, and sends the blockchain parameter request to the first blockchain 5A.

In sub-step S12B, the blockchain parameter management module 14 receives the blockchain parameter from the first blockchain 5A. Specifically, the first blockchain 5A, in response to receipt of the blockchain parameter request, sends the blockchain parameter of the first blockchain 5A to the server device 1. It should be mentioned that, in this embodiment, the blockchain parameter includes a block hash of the first blockchain 5A, such as 0000abc1234 . . . , but the disclosure is not limited to such.

In this embodiment, the server device 1 is further communicatively connected to the verifiable RN generation platform 6 for receiving the at least one randomness parameter therefrom. The verifiable RN generation platform 6 includes a decentralized verifiable RN generation service, such as a chainlink verifiable random function (VRF) or a distributed randomness beacon daemon, which is configured to generate the at least one randomness parameter. In other embodiments, the verifiable RN generation platform 6 may utilize a commit-reveal protocol and may generate a hash value as the randomness parameter during a commit phase of the protocol, but the verifiable RN generation platform 6 is not limited to such.

In addition to executing sub-step S12A, the server processing module 13, in response to receipt of the RN generation request, in sub-step S12C generates a randomness parameter request that requests the generation of at least one randomness parameter, and sends the randomness parameter request to the verifiable RN generation platform 6. The verifiable RN generation platform 6 generates the at least one randomness parameter, such as xyz and 5678, in response to receipt of the randomness parameter request.

In sub-step S12D, the server processing module 13 receives the at least one randomness parameter from the verifiable RN generation platform 6.

In sub-step S12E, the server processing module 13 generates the RN generation parameter based on the at least one randomness parameter and the blockchain parameter, and stores the RN generation parameter, the at least one randomness parameter and the blockchain parameter in the server storage module 12. For example, the server processing module 13 may generate the RN generation parameter by concatenating the blockchain parameter with the at least one randomness parameter (e.g., 0000abc1234 . . . xyz5678), but the disclosure is not limited to such.

In other embodiments, the server device 1 is connected to a plurality of verifiable RN generation platforms 6, and the server processing module 13, in sub-step S12C, generates and sends a plurality of randomness parameter requests respectively to the verifiable RN generation platforms 6. Each of the verifiable RN generation platforms 6 generates a randomness parameter in response to receipt of the respective randomness parameter request. The server processing module 13 generates the RN generation parameter based on the plurality of randomness parameters from the verifiable RN generation platforms 6 and the blockchain parameter from the first blockchain 5A.

In step S13, the server processing module 13 generates n number of leaf node hashes using a hash function based on the RN generation parameter and n number of node identifiers. In one embodiment, the hash function is exemplified by a secure hash algorithm (SHA) algorithm such as an algorithm in the SHA-2 or SHA-3 family, but the hash function is not limited to such. In this embodiment, the server processing module 13 generates the n number of leaf node hashes as the n RNs that are to be generated. Specifically, the n number of node identifiers are different from each other, and the n number of leaf node hashes are thus different from each other.

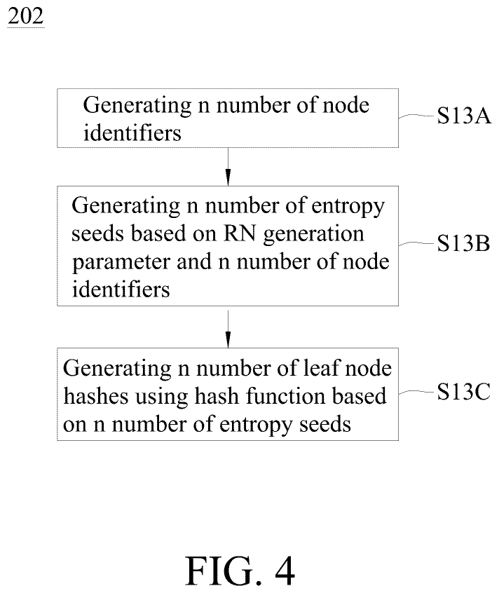

Referring to FIG. 4, step S13 includes a leaf node generation procedure 202, which includes sub-steps of S13A to S13C.

In sub-step S13A, the server processing module 13 generates the n number of node identifiers based on the RN generation request. Specifically, the n number of node identifiers are unique codes generated randomly or sequentially by the server processing module 13. The quantity of the node identifiers is equal to the generation quantity included in the RN generation request (i.e., the n RNs that are to be generated).

In sub-step S13B, for each of the n number of node identifiers, the server processing module 13 generates a corresponding one of n number of entropy seeds based on the RN generation parameter and the node identifier.

In sub-step S13C, for each of the n number of entropy seeds, the server processing module 13 generates a corresponding one of the n number of leaf node hashes using the hash function based on the entropy seed.

In step S14, the server processing module 13 constructs a Merkle tree using a Merkle tree construction algorithm based on the n number of leaf node hashes. In one embodiment, the Merkle tree construction algorithm may be a binary Merkle tree algorithm for recursively hashing the n number of leaf node hashes layer-by-layer to generate a plurality of non-leaf node hashes and a root hash. In this embodiment, the n number of leaf node hashes serve as the bottom level of the Merkle tree. The non-leaf node hashes are internal nodes in the Merkle tree obtained by, for example, concatenating two hash values of two of the n number of leaf node hashes to obtain a concatenated value, and applying the hash function to the concatenated value. The root hash is obtained by recursively hashing non-leaf node values, and represents the entire set of the n number of leaf node hashes in a compact form. The server processing module 13 then stores the Merkle tree thus constructed in the server storage module 12.

In step S15, the server processing module 13 directs the blockchain parameter management module 14 to sends the root hash to the second blockchain 5B so as to store the root hash in the second blockchain 5B, and the flow returns to step S11 for the server processing module 13 to receive another RN generation request. It should be mentioned that, in this embodiment, the second blockchain 5B is a layer-2 (scaling) network that is a layer-2 protocol built on top of a layer-1 (base) network for increasing a scalability of the layer-1 network such as in transaction capabilities, application scenarios and computing speed of the layer-1 network. For example, the layer-2 network may be implemented as a zero-knowledge (ZK) Rollup protocol, but the disclosure is not limited in this respect. In some embodiments, the server processing module 13 further sends additional data to the second blockchain 5B so as to store the additional data in the second blockchain 5B. The additional data may include data that correspond to each of the n number of leaf node hashes such as a generation timestamp, the RN generation parameter and one of the n number of node identifiers, but the disclosure is not limited in this respect. The generation timestamp is a record of the time at which a corresponding one of the n number of leaf node hashes is generated.

The second blockchain 5B receives the root hash and stores the root hash in the second blockchain 5B. In those embodiments where the server processing module 13 further sends the additional data, the second blockchain 5B further stores the additional data in the second blockchain 5B.

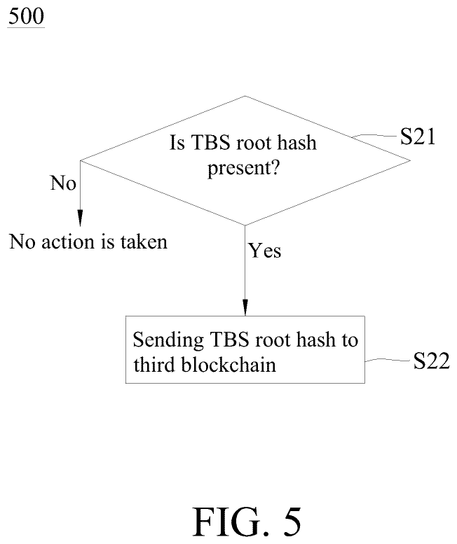

Referring to FIG. 5, in one embodiment, the method for gaming RN generation further includes an RN on-chain upload procedure 500. The RN on-chain upload procedure 500 includes steps S21 to S22, and is executed to store the root hash that is generated each time the RN generation procedure 200 is executed in a blockchain transaction, so that the root hash becomes part of an immutable ledger of the blockchain. In this embodiment, after each iteration of the RN generation procedure 200, a root hash is generated, and the root hash thus generated is further stored in the third blockchain 5C. When a root hash has yet to be stored in the third blockchain 5C, the root hash is referred to as a to-be-stored (TBS) root hash. For example, when the RN generation procedure 200 is executed at least once, at least one root hash is generated, and the at least one root hash that has yet to be stored in the third blockchain 5C is referred to as the at least one TBS root hash.

In step S21, the server processing module 13 periodically determines whether the at least one TBS root hash is present. When the determination is positive, the flow goes to step S22; otherwise, no action is taken by the server processing module 13. For example, the server processing module 13 may conduct the determination at a predetermined time interval that may be set by the administrator, but the disclosure is not limited to such. The at least one TBS root hash may be flagged with an upload status that indicates whether it has been uploaded to the third blockchain 5C, and the server processing module 13 may conduct the determination based on the upload status of the at least one TBS root hash, but the disclosure is not limited in this respect.

In step S22, the server processing module 13 sends the at least one TBS root hash to the third blockchain 5C so as to store the at least one TBS root hash in the third blockchain 5C. In one embodiment, the third blockchain 5C is a layer-1 network, such as Ethereum®, although the disclosure is not limited in this respect.

The third blockchain 5C, in response to receipt of the at least one TBS root hash, stores the at least one TBS root hash in the third blockchain 5C.

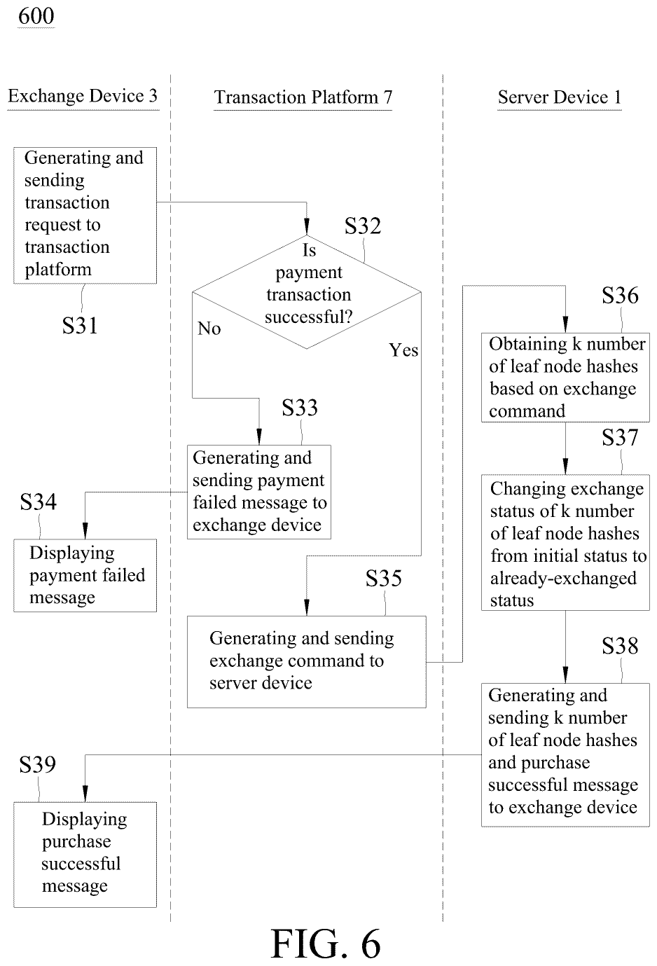

Referring to FIGS. 1 and 6, in an application scenario, an example where a customer that is a provider of a gaming system performing a purchase of k number of RNs for a designated terminal (not shown) is described below, where 1<k≤n. In this example, the customer is purchasing the k number of RNs to be used in, for example, but not limited to, loot-driven games (e.g., Diablo® and Path of Exile®) or gaming machines (e.g., slot machines and fish-hunting machines). In the illustrative FIG. 1, the customer may perform the purchase using an exchange device 3. The designated terminal may be a device that is configured to directly use the RNs, such as the slot machine or the fish-hunting machine, although the designated device is not limited thereto. The server device 1 is communicatively connected to the designated terminal.

The exchange device 3 may be exemplified as a laptop, a notebook computer, a smart phone, or a desktop computer, but is not limited to such. The exchange device 3 includes an exchange processing module 34 (e.g., an MCU), and an exchange input module 32 (e.g., a touch screen module), an exchange communication module 31 (e.g., a Wi-Fi module) and an exchange display module 33 (e.g., a display) that are electrically connected to the exchange processing module 34. In this example, the server device 1 is further communicatively connected to the exchange device 3 and a transaction platform 7. The transaction platform 7 may be a third-party system that manages payment processing between the customer (provider of the gaming system/exchange device 3) and a service provider (RNs provider/server device 1). In this embodiment, the transaction platform 7 is configured to confirm a payment by the customer for the purchase of the k RNs, before the server device 1 provides the k RNs.

Each of the n number of leaf node hashes includes an exchange status that indicates whether the leaf node hash has been exchanged (i.e., been broadcast to other nodes). In this embodiment, the exchange status is a yet-to-exchange status or an already-exchanged status. The yet-to-exchange status serves as an initial status and indicates that the leaf node hash has yet to be exchanged. The already-exchanged status indicates that the leaf node hash has been exchanged.

Referring to FIG. 6, the server device 1, the exchange device 3 and the transaction platform 7 cooperatively perform an exchange procedure 600. The exchange procedure 600 includes steps S31 to S39.

It should be noted that, the transaction platform 7 and the exchange device 3 may conduct transactions using fiat currency or virtual currency, and since ways of conducting transactions using fiat currency or virtual currency are well known in the art, and are not important features of this disclosure, further descriptions thereof will be omitted for the sake of brevity. In one embodiment, the transaction platform 7 may utilize the Ethereum® network as its underlying blockchain infrastructure. The transaction platform 7 may utilize a smart contract to calculate a payment amount based on a total quantity of transaction requests received over a period of time, and transmit the payment amount to the exchange device 3. However, the way of calculating the payment amount using the smart contract is not limited to such.

In step S31, the exchange input module 32 of the exchange device 3 receives, from the customer, a customer input signal related to an exchange quantity that indicates a quantity of RNs (i.e., k in this example) to be exchanged. The exchange processing module 34, in response to receipt of the customer input signal, generates and sends one of the transaction requests to the transaction platform 7 through the exchange communication module 31. Each of the transaction requests includes the exchange quantity. In some embodiments, the exchange input module 32 receives from the customer the customer input signal further related to the designated terminal. The transaction request thus further includes transmission data that includes the designated terminal. Specifically, in such embodiments, the server device 1 is further configured to later send the k RNs that are exchanged directly to the designated terminal based on the transmission data. The transmission data may further include a public key of the exchange device 3, a connection identifier (ID) of the designated terminal (e.g., a WebSocket ID that conforms to the WebSocket protocol), and/or a unique ID of the exchange device 3, but is not limited to such.

In step S32, the transaction platform 7, in response to receipt of the transaction request from the exchange device 3, determines whether a payment transaction corresponding to the transaction request has been successfully made by the exchange device 3. When the determination is affirmative, the flow goes to step S35; the flow goes to step S33 when otherwise.

In step S33, the transaction platform 7 generates and sends a payment failed message to the exchange device 3.

In step S34, the exchange processing module 34, in response to receipt of the payment failed message through the exchange communication module 31, controls the exchange display module 33 to display the payment failed message to notify the customer

### That the Payment Transaction Was Unsuccessful.

In step S35, the transaction platform 7 generates and sends to the server device 1, an exchange command that includes the exchange quantity, and that indicates that the payment transaction by the exchange device 3 was successful. In some embodiments, the exchange command may further include the transmission data so that the server device 1 may later send the k RNs that are exchanged directly to the designated terminal.

In step S36, the server processing module 13 of the server device 1 receives the exchange command via the server communication module 11, and obtains k number of leaf node hashes from among the n number of leaf node hashes previously generated by the server device 1 in the RN generation procedure 200 based on the exchange command. At this time, the exchange status of each of the k number of leaf node hashes is the initial status (i.e., yet-to-exchanged status). In one embodiment, the server processing module 13 obtaining the k number of leaf node hashes from among the n number of leaf node hashes is obtained by way of random selection, but the disclosure is not limited in this respect.

In step S37, the server processing module 13 performs a status change procedure that changes the exchange status of each of the k number of leaf node hashes from the initial status to the already-exchanged status.

In step S38, the server processing module 13 of the server device 1 generates and sends to the exchange device 3 a purchase successful message indicating that the purchase of the k number of RNs was successful and that exchange status of the k number of leaf node hashes have been changed. In this step, the server processing module 13 further sends the k number of leaf node hashes to the exchange device 3. In some embodiments, the server processing module 13 may further send the k number of RNs to the designated terminal based on the transmission data received earlier in the step of S31 or S35.

In step S39, the exchange processing module 34 of the exchange device 3 receives the purchase successful message via the exchange communication module 31, and controls the exchange display module 33 to display the purchase successful message.

In some embodiments, the exchange processing module 34 of the exchange device 3, in response to receipt of the customer input signal, may directly generate and send the exchange command that includes the exchange quantity to the server device 1 to obtain the k number of RNs (i.e., the k number of leaf node hashes) from the server device 1. That is to say, in such embodiments, steps S31 and S34 may be omitted, and the exchange device 3 may perform step S35 to directly obtain the k number of RNs from the server device 1.

By virtue of the abovementioned arrangements, the n number of leaf node hashes (i.e., the n RNs) are generated by the server device 1, rather than by a game provider/operator, and the root hash in the Merkle tree that corresponds to the n number of leaf node hashes is uploaded onto the second blockchain 5B, the leaf node hashes (i.e., the RNs) are traceable, verifiable, and tamper-proof. Furthermore, since the RNs are generated beforehand, the customer can purchase and deploy the k RNs within the gaming system immediately, ensuring instantaneous response. In other words, with the n number of leaf node hashes generated in batches, the customer can purchase and utilize the RNs without delay.

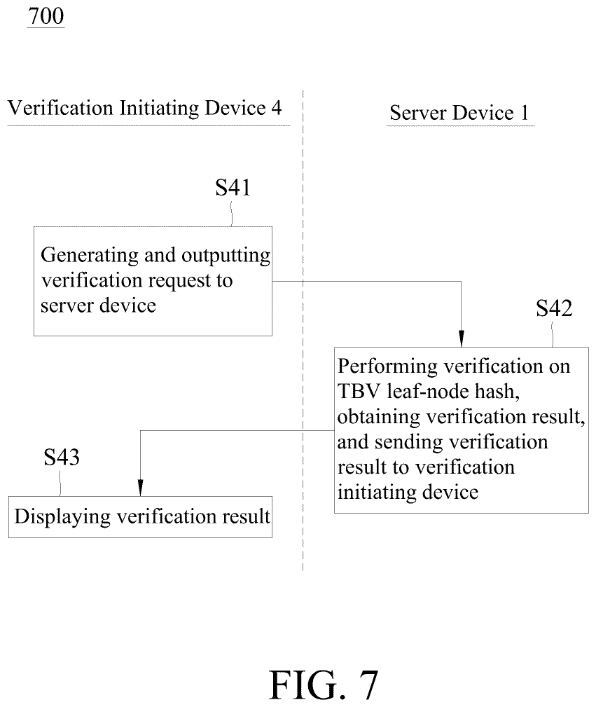

Continuing with the above example, when a player of the gaming system wishes to perform verification on the RNs that are used in the game, referring to FIGS. 1 and 7, a verification procedure 700 which includes steps S41 to S43 is performed.

In this example, the game player may perform the verification procedure 700 using a verification initiating device 4. The verification initiating device 4 may be exemplified by, but not limited to, a laptop, a notebook computer, a smart phone, or a desktop computer, and includes a verification processing module 44 (e.g., an MCU), and a verification communication module 41 (e.g., a Wi-Fi module), a verification input module 42 (e.g., a touchscreen module), and a verification display module 43 (e.g., the touchscreen module or another display) that are electrically connected to the verification processing module 44. The verification initiating device 4 is communicatively connected to the server device 1. The verification input module 42 is operable by the player, where the player may input an RN (i.e., a leaf node hash to be verified) (hereinafter referred to as “the to-be-verified (TBV) leaf-node hash”), and the verification input module 42 generates and outputs a player input signal that includes the TBV leaf-node hash.

In step S41, the verification processing module 44 of the verification initiating device 4, in response to receipt of the player input signal, generates and outputs a verification request that includes the TBV leaf-node hash to the server device 1 via the verification communication module 41.

In this example, the server processing module 13 of the server device 1 is further configured to, in response to receipt of the verification request via the server communication module 11, generate and output a verification result to the verification initiating device 4 by using the following step.

In step S42, the server processing module 13, in response to receipt of the verification request, performs verification on the TBV leaf-node hash included in the verification request to obtain the verification result based on the TBV leaf-node hash, and at least one of the non-leaf node hashes and the root hash in the Merkle tree from which the k number of leaf node hashes were obtained. In this example, the server processing module 13 performs the verification using the Merkle proof technique, but the disclosure is not limited to such. Specifically, by using the Merkle proof technique, the server processing module 13 determines whether the TBV leaf-node hash corresponds to any of the n number of leaf node hashes in the Merkle tree (since the k number of leaf node hashes are obtained from among the n number of leaf node hashes). In a case where the TBV leaf-node hash matches one of the n number of leaf node hashes in the Merkle tree (e.g., the TBV leaf-node hash is identical to said one of the n number of leaf node hashes), the at least one non-leaf node hash that corresponds to said one of the n number of leaf node hashes will construct a Merkle path from said one of the n number of leaf node hashes to the root hash of the Merkle tree. The server processing module 13 then sends the verification result that indicates that the TBV leaf-node hash belongs to the Merkle tree to the verification initiating device 4.

In step S43, the verification processing module 44 receives the verification result from the server device 1 via the verification communication module 41, and controls the verification display module 43 to display the verification result to notify the player that the TBV leaf-node hash has been verified.

Should the TBV leaf-node hash fail to match any of the n number of leaf node hashes in the Merkle tree in step S42, no Merkle path can be constructed. Consequently, the server processing module 13 sends the verification result that indicates that the TBV leaf-node hash does not belong to the Merkle tree to the verification initiating device 4. In step S43, the verification display module 43 displays the verification result to notify the player that the TBV leaf-node hash has failed verification.

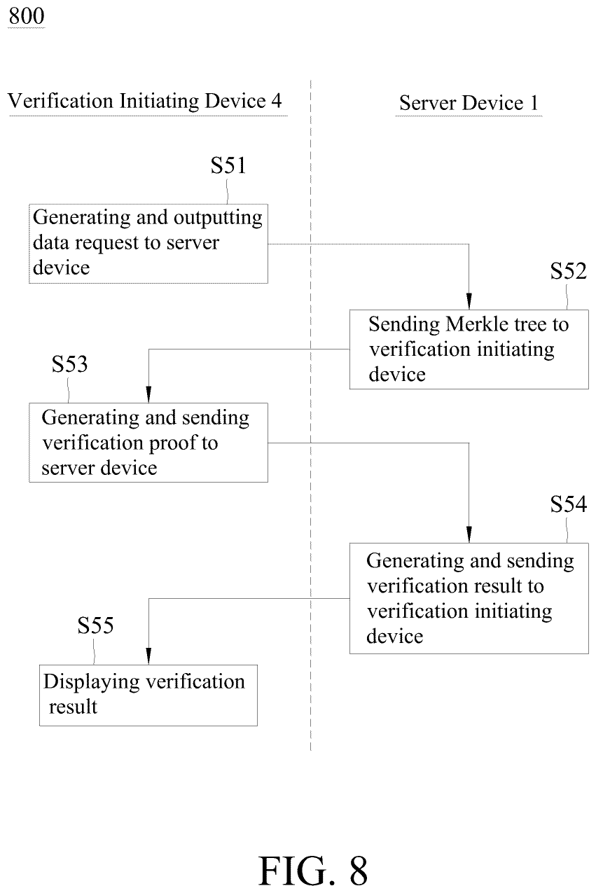

Referring to FIGS. 1 and 8, in another example, the player may perform verification on the RNs using another verification procedure 800 that includes steps S51 to S55. In this example, the verification input module 42 is operable by the player to generate and output a data request signal related to the TBV leaf-node hash.

In step S51, the verification processing module 44 of the verification initiating device 4, in response to receipt of the data request signal, generates and outputs a data request to the server device 1 via the verification communication module 41.

In step S52, the server processing module 13 of the server device 1 in response to receipt of the data request via the server communication module 11, sends the Merkle tree to the verification initiating device 4 based on the data request.

In step S53, the verification processing module 44 (acting as a Prover in this Zero-Knowledge Proof context) receives the Merkle tree via the verification communication module 41, and generates a verification proof using a zero-knowledge proof protocol (e.g., the zero-knowledge succinct non-interactive argument of knowledge (zk-SNARK) protocol) based on the TBV leaf-node hash and the Merkle tree. The verification processing module 44 then sends the verification proof to the server device 1 via the verification communication module 41.

In step S54, the server processing module 13 (acting as a Verifier in this Zero-Knowledge Proof context) receives the verification proof via the server communication module 11, generates the verification result using the zk-SNARK protocol based on the verification proof. The verification result indicates whether the TBV leaf-node hash matches one of the n number of leaf node hashes of the Merkle tree. The server processing module 13 then sends the verification result to the verification initiating device 4 via the server communication module 11.

In step S55, the verification processing module 44 receives the verification result via the verification communication module 41, and controls the verification display module 43 to display the verification result.

It is noted that, the customer may initiate the exchange procedure 600 to purchase RNs, and the player may initiate the verification procedure 700 or 800 to verify those RNs thus purchased, with both actions being facilitated through an application programming interface (API) or application (APP). This mechanism thereby facilitates the easy obtainability of the RNs, while ensuring traceability, fairness, verifiability and tamper-proof nature of the RNs.

In summary, the system 100 for gaming random number generation of this disclosure is able to perform the RN generation procedure 200 to generate the n number of leaf node hashes in batches, and store and upload the root hash of the n number of leaf node hashes on the second blockchain 5B. By virtue of the aforementioned arrangement, the n number of leaf node hashes are traceable, verifiable for proving its impartiality (i.e., not tampered), and the customer can immediately obtain the leaf node hashes from the server device 1 by purchasing RNs from the administrator. Furthermore, in those embodiments where the method for gaming random number generation include the RN on-chain upload procedure 500, the at least one root hash is periodically uploaded onto the third blockchain 5C that is the layer-1 blockchain, the n number of leaf node hashes become traceable and untamperable.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for gaming random number (RN) generation implemented by a system that includes a server device, the server device adapted to being communicatively connected to a first blockchain and a second blockchain, the method comprising steps of, by the server device:
A) generating an RN generation parameter based on at least one randomness parameter and a blockchain parameter that is obtained from the first blockchain, where the RN generation parameter includes the at least one randomness parameter and the blockchain parameter;
B) generating n number of leaf node hashes as n random numbers (RNs) that are to be generated using a hash function based on the RN generation parameter and n number of node identifiers, where the n number of node identifiers are different from each other, the n number of leaf node hashes are different from each other, and n>1;
C) generating a root hash using a Merkle tree construction algorithm based on the n number of leaf node hashes; and
D) sending the root hash to the second blockchain so as to store the root hash in the second blockchain.

2. The method as claimed in claim 1, wherein the blockchain parameter includes a block hash of the first blockchain.

3. The method as claimed in claim 1, the server device adapted to being further communicatively connected to a verifiable RN generation platform,
wherein in step A), the at least one randomness parameter is obtained from the verifiable RN generation platform.

4. The method as claimed in claim 1, the server device being further communicatively connected to a management device for receiving an RN generation request therefrom,
wherein in step A), the RN generation parameter is generated in response to receipt of the RN generation request that is from the management device and that includes a generation quantity which indicates that n number of RNs are to be generated; and
wherein step B) includes sub-steps of:
B1) generating the n number of node identifiers based on the RN generation request,
B2) for each node identifier of the n number of node identifiers, generating an entropy seed that corresponds to the node identifier based on the RN generation parameter and the node identifier, and
B3) for each entropy seed of n number of entropy seeds corresponding respectively to the n number of node identifiers, generating a corresponding one of the n number of leaf node hashes using the hash function based on the entropy seed.

5. The method as claimed in claim 1, the server device adapted to being further communicatively connected to a third blockchain, wherein step D) includes, after sending the root hash to the second blockchain, returning to step A),
wherein steps A) to D) are executed at least once for the server device to generate at least one root hash,
the method further comprising steps of, by the server device:
E) periodically determining whether the at least one root hash that has yet to be stored in the third blockchain is present; and
F) in response to determining that the at least one root hash has yet to be stored in the third blockchain, sending the at least one root hash to the third blockchain so as to store the at least one root hash in the third blockchain, the third blockchain being a layer-1 blockchain.

6. The method as claimed in claim 1, the server device adapted to being further communicatively connected to an exchange device, wherein for each of the n number of leaf node hashes, the leaf node hash includes an exchange status, the exchange status being one of a yet-to-exchange status that serves as an initial status and that indicates that the leaf node hash has yet to be exchanged, and an already-exchanged status that indicates that the leaf node hash has been exchanged,
the method further comprising steps of, after step D), by the server device:
G) in response to receipt of an exchange command that includes an exchange quantity which indicates that k number of leaf node hashes are to be exchanged, obtaining k number of leaf node hashes from among the n number of leaf node hashes, the exchange status of each of the k number of leaf node hashes being the yet-to-exchange status, where 1<k≤n; and
H) changing the exchange status of each of the k number of leaf node hashes to the already-exchanged status.

7. The method as claimed in claim 6, the method further comprising at least one of steps of, after step H), by the server device:
I-1) sending the k number of leaf node hashes to the exchange device;
I-2) sending a purchase successful message indicating that the purchase of the k number of RNs was successful and that exchange status of the k number of leaf node hashes have been changed; and
I-3) sending the k number of leaf node hashes to a designated terminal that is connected to the server device and is configured to directly use the RNs.

8. The method as claimed in claim 6, the server device adapted to being further communicatively connected to a transaction platform, wherein the exchange command in step G) is sent from the transaction platform; the exchange command includes the exchange quantity, and indicates a completion of a payment transaction by the exchange device.

9. The method as claimed in claim 1, the server device adapted to being further communicatively connected to an exchange device, a transaction platform, and a designated terminal, wherein for each of the n number of leaf node hashes, the leaf node hash includes an exchange status, the exchange status being one of a yet-to-exchange status that serves as an initial status and that indicates that the leaf node hash has yet to be exchanged, and an already-exchanged status that indicates that the leaf node hash has been exchanged,
the method further comprising steps of, after step D), by the server device:
J) in response to receipt of an exchange command that is from the transaction platform, that includes an exchange quantity indicating k number of leaf node hashes are to be exchanged and transmission data related to the designated terminal, and that indicates a completion of a payment transaction by the exchange device, obtaining k number of leaf node hashes from among the n number of leaf node hashes, where 1<k≤n and the exchange status of each of the k number of leaf node hashes is the yet-to-exchange status; and
K) changing the exchange status of each of the k number of leaf node hashes to the already-exchanged status.

10. The method as claimed in claim 9, the method further comprising at least one of steps of, after step H), by the server device:
L-1) sending the k number of leaf node hashes to the exchange device;
L-2) sending a purchase successful message indicating that the purchase of the k number of RNs was successful and that exchange status of the k number of leaf node hashes have been changed; and
L-3) sending the k number of leaf node hashes to the designated terminal that is indicated by the transmission data.

11. The method as claimed in claim 1, the server device adapted to being further communicatively connected to a verification initiating device, wherein step C) includes generating a Merkle tree using the Merkle tree construction algorithm based on the n number of leaf node hashes, and the Merkle tree includes the n number of leaf node hashes, a plurality of non-leaf node hashes, and the root hash,
the method further comprising a step of, after step D), by the server device:
M) in response to receipt of a verification request that is from the verification initiating device and that includes a to-be-verified (TBV) leaf-node hash to be verified, performing verification based on the TBV leaf-node hash, and at least one of the plurality of non-leaf node hashes and the root hash in the Merkle tree, generating and sending to the verification initiating device a verification result that indicates whether the TBV leaf-node hash corresponds to one of the n number of leaf node hashes of the Merkle tree.

12. The method as claimed in claim 1, the server device adapted to being further communicatively connected to a verification initiating device, wherein step C) includes generating a Merkle tree using the Merkle tree construction algorithm based on the n number of leaf node hashes, and the Merkle tree includes the n number of leaf node hashes, a plurality of non-leaf node hashes, and the root hash,
the method further comprising steps of, after step D), by the server device:
N) in response to receipt of a data request from the verification initiating device, sending the Merkle tree to the verification initiating device for the verification initiating device to generate a verification proof using a zero-knowledge proof protocol based on a to-be-verified (TBV) leaf-node hash that corresponds to an RN to be verified and the Merkle tree, and to send the verification proof thus generated to the server device; and
O) in response to receipt of the verification proof from the verification initiating device, generating a verification result using the zero-knowledge proof protocol based on the verification proof, and sending the verification result to the verification initiating device, the verification result indicating whether the TBV leaf-node hash corresponds to one of the n number of leaf node hashes of the Merkle tree.

13. The method as claimed in claim 1, wherein step D) includes sending to the second blockchain, a generation timestamp, the RN generation parameter and one of the n number of node identifiers that correspond to each of the n number of leaf node hashes, so as to store the generation timestamp, the RN generation parameter and said one of the n number of node identifiers that correspond to each of the n number of leaf node hashes in the second blockchain.

14. A system for gaming random number (RN) generation, comprising:
a server device adapted to be communicatively connected to a first blockchain and a second blockchain,
wherein said server device is configured to perform a method as claimed in claim 1 for generating the n number of leaf node hashes and the root hash.
